(19) United States
(12) Patent Application Publication
(10) Pub. No.: US 2011/0011258 A1
(43) Pub. Date: Jan. 20, 2011

(54) LINEAR COMPRESSOR

(75) Inventors: Kyoung-Seok KANG, Changwon-shi (KR); Yang-Jun Kang, Changwon-shi (KR); Min-Woo Lee, Gimhae-shi (KR); Chul-Gi Roh, Changwon-shi (KR)

Correspondence Address: KED & ASSOCIATES, LLP, P.O. Box 221200, Chantilly, VA, 20153-1200, US

(73) Assignee: LG Electronics Inc.

(21) Appl. No.: 12/888,734

(22) Filed: Sep. 23, 2010

Related U.S. Application Data
(62) Division of application No. 11/652,548, filed on Jan. 12, 2007.

(30) Foreign Application Priority Data
Jan. 16, 2006 (KR) 10-2006-0004633
Jan. 16, 2006 (KR) 10-2006-0004634

(51) Int. Cl. F16J 1/01

(52) U.S. Cl. 92/172

(57) ABSTRACT

The present invention discloses a linear compressor including a cylinder in which refrigerants flow to the axial direction, a piston reciprocated inside the cylinder, for compressing the refrigerants, and a linear motor for driving the piston. At least one of the cylinder and the piston is sintering molded.

This application is a Divisional of U.S. patent application Ser. No. 11/652,548, filed in the U.S. on Jan. 12, 2007, which claims priority to Korean Patent Application Nos. 10-2006-0004633, filed on Jan. 16, 2006 and 10-2006-0004634, filed Jan. 16, 2006, the entirety of which are incorporated herein by reference.

### TECHNICAL FIELD

The present invention relates to a linear compressor with a piston linearly reciprocated inside a cylinder, for supplying refrigerants into a compression space between the piston and the cylinder, compressing the refrigerants, and discharging the refrigerants, and more particularly, to a linear compressor which can omit special mechanical processing, by molding at least one of a piston and a cylinder by using a sintering material.

### BACKGROUND ART

FIG. 1 is a side-sectional view illustrating part of a conventional linear compressor, and FIG. 2 is a side-sectional view illustrating a piston of the conventional linear compressor.

Referring to FIG. 1, in the conventional linear compressor, one end of a cylinder 2 is fixedly supported by a main body frame 3 in a hermetic space inside a shell (not shown), and one end of a piston 4 is inserted into the cylinder 3. A compression space P is formed between the cylinder 2 and the piston 4. The piston 4 is connected to a linear motor 10 and reciprocated in the axial direction, for supplying refrigerants into the compression space P and discharging the refrigerants.

Here, the compression space P for compressing the refrigerants is formed between one end inner portion of the cylinder 2 and the piston 4. A communication hole 4b′ is formed at one end of the piston 4 in the axial direction for supplying the refrigerants into the compression space P. A thin suction valve 6 for opening and closing the communication hole 4b′ is bolt-fastened to one end of the piston 4. A discharge valve assembly 8 for discharging the refrigerants compressed in the compression space P is installed at one end of the cylinder 2.

In the discharge valve assembly 8, a discharge valve 8a is disposed to block one end of the cylinder 2, and a discharge cap 8b is fixed to one end of the cylinder 2, for temporarily storing the compressed refrigerants before externally discharging the refrigerants. The discharge valve 8a is elastically supported in the axial direction inside the discharge cap 8b by spiral discharge valve springs 8c.

The linear motor 10 includes a ring-shaped inner stator 12 fixed to the outer circumference of the cylinder 2 and formed by laminating a plurality of laminations in the circumferential direction, a ring-shaped outer stator 14 disposed outside the inner stator 12 with a predetermined gap, and formed by laminating a plurality of laminations in the circumferential direction outside a coil winding body formed by winding a coil in the circumferential direction, and a permanent magnet 16 disposed in a space between the inner stator 12 and the outer stator 14, and linearly reciprocated by mutual electromagnetic force of the inner stator 12 and the outer stator 14.

One end of the inner stator 12 is supported by the main body frame 3, and the other end thereof is fixed to the outer circumference of the cylinder 2 by a fixing ring (not shown). One end of the outer stator 14 is supported by the main body frame 3, and the other end thereof is supported by a special motor cover 22. The motor cover 22 is bolt-fastened to the main body frame 3. The permanent magnet 16 is connected to the other end of the piston 4 through a special connection member 30.

Accordingly, when current is applied to the outer stator 14, the permanent magnet 16 is linearly reciprocated by mutual electromagnetic force of the inner stator 12 and the outer stator 14, and the piston 4 is linearly reciprocated inside the cylinder 2. As the internal pressure of the compression space P is varied, the suction valve 6 and the discharge valve 8a are opened and closed, for sucking, compressing and discharging the refrigerants.

The piston 4 applied to the conventional linear compressor will now be explained with reference to FIG. 2. The piston 4 is manufactured by casting, and comprised of a cylindrical piston main body 4a formed long in the axial direction, a compression unit 4b for blocking one end of the piston main body 4a, and a connection unit 4c extended from the other end of the piston main body 4a to the radial direction.

A guide hole 4a′ in which the refrigerants flow is formed in the axial direction in the piston main body 4a, at least one communication hole 4b′ for guiding the refrigerants flowing along the guide hole 4a′ to the compression space P is formed on the compression unit 4b, and at least one fastening hole 4c′ to which the connection member 30 is bolt-fastened is formed on the connection unit 4c, for connecting the piston 4 to the permanent magnet 16 of the linear motor 10.

Normally, low cost steel is cast into the piston 4 in a larger size than a real size. Mechanical processing such as turning and polishing is carried out on the outer circumference of the piston 4, for transforming the piston 4 to the real size. In addition, an oil circulation groove for circulating the oil, and a friction unit rubbing against the inner circumference of the cylinder 2 may be formed on the piston 4. As the piston 4 is manufactured by casting, although the piston 4 rubs against the inner portion of the cylinder 2, the friction intensity can be maintained.

However, since steel is cast into the piston 4 of the conventional linear compressor, defects frequently occur. The added processing such as turning and polishing increases the processing cost. As various holes are formed by cutting, burrs are generated to seriously reduce operation efficiency.

FIG. 3 is a perspective view illustrating the cylinder of the conventional linear compressor.

Low cost steel is cast into the cylinder 2 in a larger size than a real size. Mechanical processing such as turning and polishing is carried out on the inner and outer circumferences of the cylinder 2, for transforming the cylinder 2 to the real size. Therefore, blowhole defects frequently occur during the casting, thereby increasing a fraction defective. After the outer circumference of the cylinder 2 is mechanically processed, aluminum is die-cast into the frame 3, and the frame 3 is fixed to the outer circumference of the cylinder 2. Here, the cylinder 2 is too much mechanically processed before the die-cast and fixation of the frame 3, which increases the processing cost and decreases operation efficiency.

### DISCLOSURE OF THE INVENTION

The present invention is achieved to solve the above problems. An object of the present invention is to provide a linear compressor including a piston and a cylinder which can be easily manufactured in designed shapes and sizes without an additional process.

In order to achieve the above-described object of the invention, in one embodiment, there is provided a linear compressor, including: a cylinder in which refrigerants flow to the axial direction; a piston reciprocated inside the cylinder, for compressing the refrigerants; and a linear motor for driving the piston, wherein at least one of the cylinder and the piston is sintering molded. This may include sintering molding the cylinder, sintering molding the piston, and sintering molding both the cylinder and the piston.

In certain embodiments, at least part of the piston is sintering molded.

In certain embodiments, the piston includes at least two sintering molded members. The piston can include two or more members, and each of the members can be sintering molded.

In one embodiment, the piston includes a connection unit for interworking with the linear motor, a compression unit for compressing the refrigerants, and a piston main body for connecting the connection unit to the compression unit. At least one of the connection unit, the compression unit and the piston main body is sintering molded.

In this embodiment, the compression unit includes a communication hole for discharging the compressed refrigerants. The communication hole can be incorporated with the piston in the sintering of the piston. As compared with cutting molding of the communication hole, burrs are not generated and the process is simplified.

In this embodiment, the connection unit includes a fastening hole for connecting the piston to the linear motor. The fastening hole can be incorporated with the piston in the sintering of the piston. As compared with cutting molding of the fastening hole, burrs are not generated and the process is simplified.

In this embodiment, one of at least two members is inserted into the other member. For example, a first piston member is inserted into a second piston member, or the second piston member is inserted into the first piston member.

In this embodiment, at least two members are made of materials with different thermal expansion coefficients. By this configuration, the two members can be firmly stably coupled to each other by using the difference of the thermal expansion coefficients.

In another embodiments, the piston includes a connection unit for interworking with the linear motor, a compression unit for compressing the refrigerants, and a piston main body for connecting the connection unit to the compression unit. The connection unit and one part of the piston main body are sintering molded as a single body, and the compression unit and the other part of the piston main body are sintering molded as a single body.

In this embodiment, one part of the piston main body is coupled to the other part of the piston main body.

In another embodiment, the piston includes a connection unit for interworking with the linear motor, a compression unit for compressing the refrigerants, and a piston main body for connecting the connection unit to the compression unit. The compression unit and the piston main body are sintering molded as a single body.

In this embodiment, the connection unit includes a hole to which the piston main body is coupled.

In another embodiment, the piston includes a connection unit for interworking with the linear motor, a compression unit for compressing the refrigerants, and a piston main body for connecting the connection unit to the compression unit. The connection unit and the piston main body are sintering molded as a single body.

In this embodiment, the compression unit includes a step unit coupled to the piston main body.

In this embodiment, the cylinder is sintering molded.

In this embodiment, the cylinder includes a rotation restriction member for fixing the position of the cylinder. Here, the rotation restriction member can be disposed at any one of the cylinder and a flange unit explained later.

In this embodiment, the rotation restriction member is a rotation prevention unit disposed on the outer circumference of the cylinder. The rotation prevention unit can be any one of a convex unit and a concave unit formed on the outer circumference of the cylinder.

In this embodiment, the linear compressor includes a frame for fixing the cylinder. The cylinder includes a flange unit coupled to the frame.

In certain embodiments, the cylinder includes a rotation restriction member for fixing the position of the cylinder. The rotation restriction member is a straight line unit disposed at the flange unit.

In certain embodiments, a slope is formed on the outer circumference of the cylinder. By this configuration, for example, when the frame is formed on the cylinder by die-casting, it is possible to stably fix the frame to the cylinder without specially processing the frame formation part of the cylinder.

In certain embodiments, at least one of the cylinder and the piston is steam-processed after sintering molding. The steam processing generates an oxide film serving as a protection film for preventing corrosion and giving a lubrication characteristic to the piston and the cylinder.

In accordance with the present invention, in the linear compressor, even if the piston and the cylinder are designed in various shapes and sizes, they are manufactured as powder sintered bodies. The sintering molding secures more accurate shapes and sizes than the casting. Therefore, the additional processing such as polishing and turning is omitted to cut down the production cost. In addition, a complicate shape product can be easily manufactured by individually forming a few parts and thermally fit-pressing or welding the parts, which results in high operation efficiency. Furthermore, a material with high hardness and an excellent abrasion characteristic is used as the powder sintered body, thereby improving a mechanical characteristic.

### BRIEF DESCRIPTION OF THE DRAWINGS

The present invention will become better understood with reference to the accompanying drawings which are given only by way of illustration and thus are not limitative of the present invention, wherein:

FIG. 1 is a side-sectional view illustrating part of a conventional linear compressor;

FIG. 2 is a side-sectional view illustrating a piston of the conventional linear compressor;

FIG. 3 is a perspective view illustrating a cylinder of the conventional linear compressor;

FIG. 4 is a disassembly side-sectional view illustrating a first example of a piston of a linear compressor in accordance with the present invention;

FIG. 5 is a disassembly side-sectional view illustrating a second example of the piston of the linear compressor in accordance with the present invention;

FIG. 6 is a disassembly side-sectional view illustrating a third example of the piston of the linear compressor in accordance with the present invention; and

FIG. 7 is a perspective view illustrating a cylinder of the linear compressor in accordance with the present invention.

### BEST MODE FOR CARRYING OUT THE INVENTION

A linear compressor in accordance with the preferred embodiments of the present invention will now be described in detail with reference to the accompanying drawings.

Exemplary linear compressors include a linear compressor with a piston molded by using a sintering material, a linear compressor with a cylinder molded by using a sintering material, and a linear compressor with a piston and a cylinder molded by using a sintering material. The piston and the cylinder of the linear compressor molded by using the sintering material will now be described.

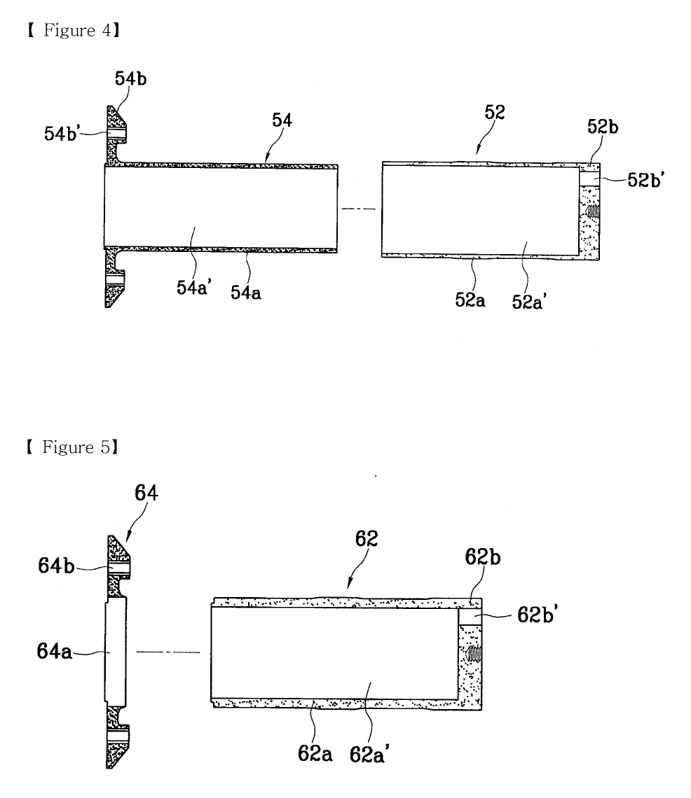

FIG. 4 is a disassembly side-sectional view illustrating a first example of the piston of the linear compressor in accordance with the present invention.

Referring to FIG. 4, the first example of the piston of the linear compressor includes a first piston member 52 consisting of an outer member 52a of a cylindrical piston main body, a compression unit 52b formed to block one end of the outer member 52a, and a communication hole 52b′ for discharging compressed fluid, and a second piston member 54 consisting of an inner member 54a of the cylindrical piston main body, and a connection unit 54b extended from one end of the inner member 54a to the radial direction. The first and second piston members 52 and 54 are manufactured as abrasion resistant powder sintered bodies with high hardness and an excellent abrasion characteristic, and coupled to each other.

The first and second piston members 52 and 54 can be individually manufactured and coupled to each other, or incorporated with each other.

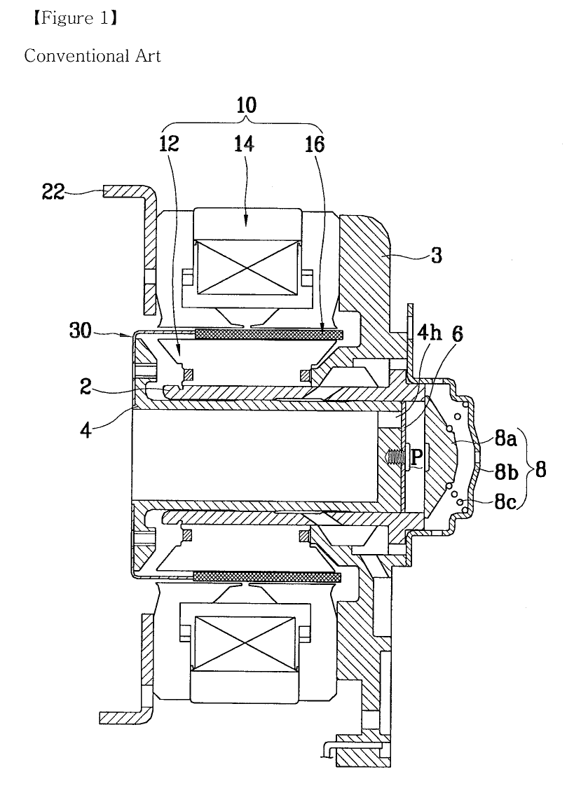

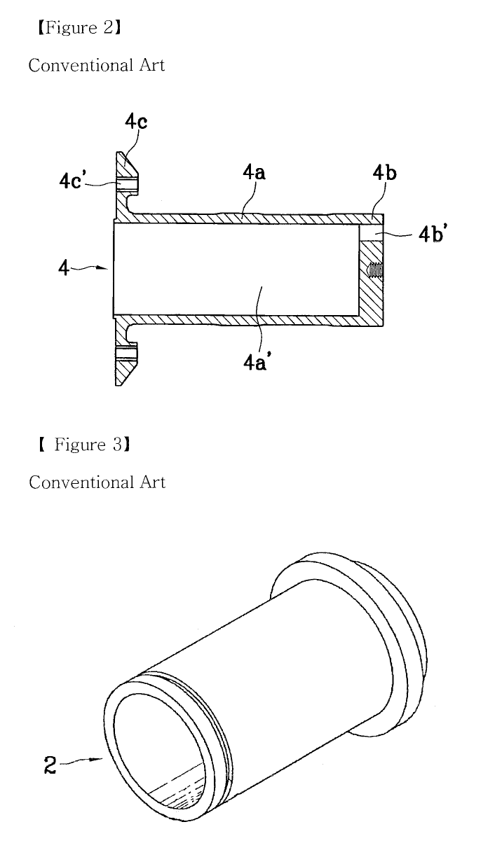

Reference numerals which are not shown are identical to those of FIG. 1.

The first piston member 52 will now be explained. The outer member 52a of the piston main body is formed in a cylindrical shape. The compression unit 52b is formed in a relatively thick disk shape to resist a high pressure of the compression space P.

A guide hole 54a′ is formed in the axial direction at the center portion, so that the inner member 54a of the piston main body can be fit-pressed into the outer member 52a of the piston main body. Fastening holes 54b′ bolt-fastened to the connection member 30 and air holes are sintering molded on the connection unit 54b as a single body. Generally, a plurality of holes are formed at regular intervals in the circumferential direction of the center of the connection unit 54b. Some holes are used as the fastening holes 54b′ bolt-fastened to the connection member 30, and the other holes are used as the air holes for cooling by air streams.

The manufacturing process of the first and second piston members 52 and 54 will now be explained. A binder which is a kind of adhesive is added to powder with relatively high abrasion resistance such as metal powder or ceramic powder. The resulting mixture is put into molds with the same sizes and shapes as those of the first and second piston members 52 and 54 having the holes, fixed, and heated over a predetermined temperature. The boundaries of the powder are adhered to each other, to form the first and second piston members 52 and 54.

The first and second piston members 52 and 54 can be manufactured as a single member, or individually manufactured and coupled to each other especially in a complicate shape. If the first and second piston members 52 and 54 are manufactured as the same powder sintered bodies, they can be coupled to each other by local welding such as copper welding. If the first and second piston members 52 and 54 are manufactured as different powder sintered bodies, they can be easily coupled to each other by heating fit-pressing.

For example, the second piston member 54 is manufactured as a powder sintered body with a higher thermal coefficient than the first piston member 52. In a state where the first piston member 52 is heated, the compression unit 52b of the first piston member 52 and the connection unit 54b of the second piston member 54 are disposed in the opposite directions, and the second piston member 54 is inserted into the first piston member 52. Since the first piston member 52 is expanded by heating, the inner member 54a of the second piston member 54 can be inserted into a fit-pressing hole 52a′ of the first piston member 52. When the first and second piston members 52 and 54 are cooled, the first piston member 52 is contracted, so that the second piston member 54 can be fit-pressed into the first piston member 52. Even if the first and second piston members 52 and 54 are heated again, the second piston member 54 is more expanded than the first piston member 52, and thus continuously fit-pressed into the first piston member 52.

FIG. 5 is a disassembly side-sectional view illustrating a second example of the piston of the linear compressor in accordance with the present invention.

As illustrated in FIG. 5, the second example of the piston of the linear compressor includes a first piston member 62 consisting of a cylindrical piston main body 62a, and a compression unit 62b formed to block one end of the piston main body 62a, and a second piston member 64 having only a disk ring-shaped connection unit engaged with the outer circumference of the other end of the piston main body 62a and extended to the radial direction. The first and second piston members 62 and 64 are manufactured as abrasion resistant powder sintered bodies, and coupled to each other.

The first piston member 62 will now be explained. The piston main body 62a is formed in a cylindrical shape. The compression unit 62b is formed in a relatively thick disk shape to resist a high pressure of the compression space P.

A guide hole 62a′ for guiding refrigerants to the axial direction is formed at the center portion of the piston main body 62a. At least one communication hole 62b′ for supplying the refrigerants into the compression space P and/or bolt grooves for fixing the thin plate type suction valve 6 are sintering molded on the compression unit 62b as a single body.

An oil supply groove and a friction unit can be formed on the outer circumference of the piston main body 62a by additional processing.

The second piston member 64 will now be explained. A fit-pressing hole 64a with a smaller diameter than the outside diameter of the piston main body 62a is formed in the axial center, so that one opened end of the piston main body 62a can be fit-pressed into the fit-pressing hole 64a. In addition to the fit-pressing hole 64a, fastening holes 64b bolt-fastened to the connection member 30 connected to the permanent magnet 16 of the linear motor 10, and air holes are sintering molded as a single body.

Normally, a plurality of holes are formed at regular intervals in the circumferential direction of the center of the second piston member 64. Some holes are used as the fastening holes 64b bolt-fastened to the connection member 30, and the other holes to which bolts are not fastened are used as the air holes for cooling by air streams.

The manufacturing process of the first and second piston members 62 and 64 is identical to that of the first and second piston members 52 and 54 described above, and thus detailed explanations thereof are omitted.

If the first and second piston members 62 and 64 are manufactured as the same powder sintered bodies, they can be coupled to each other by local welding such as copper welding. If the first and second piston members 62 and 64 are manufactured as different powder sintered bodies, they can be easily coupled to each other by heating fit-pressing.

For example, the second piston member 64 is manufactured as a powder sintered body with a lower thermal coefficient than the first piston member 62. In a state where one opened end of the first piston member 62 opposite to the compression unit 62b is positioned to face the fit-pressing hole 64a of the second piston member 64, the second piston member 64 is heated. Since the second piston member 64 is expanded by heating, the opened end of the first piston member 62 can be easily inserted into the fit-pressing hole 64a of the second piston member 64. Even if the first and second piston members 62 and 64 are heated again, the first and second piston members 62 and 64 are cooled to keep the fit-pressing state.

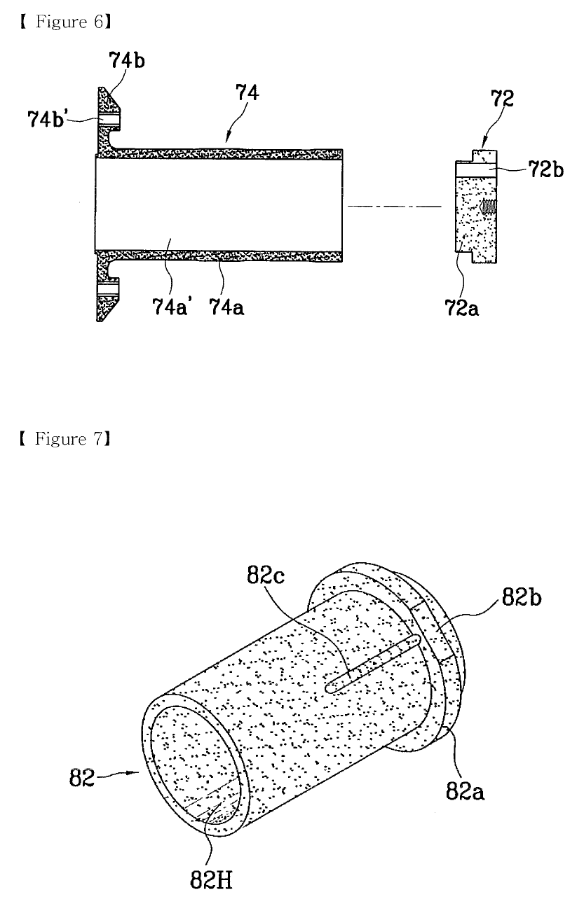

FIG. 6 is a disassembly side-sectional view illustrating a third example of the piston of the linear compressor in accordance with the present invention.

As shown in FIG. 6, the third example of the piston of the linear compressor includes a first piston member 72 having a compression unit, a step unit 72a being protruded from the center of one surface of the first piston member 72 to the axial direction, and a second piston member 74 consisting of a cylindrical piston main body 74a, the step unit 72a of the first piston member 72 being fit-pressed into one end of the piston main body 74a, and a disk ring-shaped connection unit 74b extended from the other end of the piston main body 74a to the radial direction. The first and second piston members 72 and 74 are manufactured as abrasion resistant powder sintered bodies, and coupled to each other.

The first piston member 72 will now be explained. The first piston member 72 is formed in a relatively thick disk shape to resist a high pressure of the compression space P. The step unit 72a is protruded from the center of one surface of the first piston member 72 with a height difference, and inserted into one end of the piston main body 74a. At least one communication hole 72b for guiding the refrigerants flowing to the axial direction into the compression space P is formed at one side of the step unit 72a.

Here, the step unit 72a and the communication hole 72b passing through one side of the step unit 72a are sintering molded on one surface of the first piston member 72, and bolt grooves for fixing the thin plate type suction valve 6 are sintering molded on the other surface thereof as a single body.

The second piston member 74 will now be explained. The piston main body 74a is formed in a cylindrical shape. The inside diameter of the piston main body 74a is smaller than the diameter of the step unit 72a, so that the step unit 72a can be fit-pressed into one end of the piston main body 74a. The connection unit 74b is formed in a disk ring shape extended from one end of the piston main body 74a to the radial direction, and coupled to the connection member 30 connected to the permanent magnet 16 of the linear motor 10.

The piston main body 74a includes a guide hole 74a′ for guiding the refrigerants to the axial direction and supplying the refrigerants to the communication hole 72b. The step unit 72a is fit-pressed into one end of the guide hole 74a′. In addition, an oil supply groove and a friction unit can be sintering molded on the outer circumference of the piston main body 74a as a single body by additional processing.

Fastening holes 74b′ bolt-fastened to the connection member 30, and air holes are sintering molded on the connection unit 74b as a single body. Normally, a plurality of holes are formed at regular intervals in the circumferential direction of the center of the connection unit 74b. Some holes are used as the fastening holes 74b′ bolt-fastened to the connection member 30, and the other holes to which bolts are not fastened are used as the air holes for cooling by air streams.

The manufacturing process of the first and second piston members 72 and 74 is identical to that of the first and second piston members 52 and 54 described above, and thus detailed explanations thereof are omitted.

If the first and second piston members 72 and 74 are manufactured as the same powder sintered bodies, they can be coupled to each other by local welding such as copper welding. If the first and second piston members 72 and 74 are manufactured as different powder sintered bodies, they can be easily coupled to each other by heating fit-pressing.

For example, the second piston member 74 is manufactured as a powder sintered body with a lower thermal coefficient than the first piston member 72. In a state where the step unit 72a of the first piston member 72 is positioned to face the cpened one end of the second piston member 74 opposite to the connection unit 74b, the second piston member 74 is heated. Since the second piston member 74 is expanded by heating, the step unit 72a of the first piston member 72 can be easily inserted into the guide hole 74a′ of the second piston member 74. Even if the first and second piston members 72 and 74 are heated again, the first and second piston members 72 and 74 keep the fit-pressing state.

FIG. 7 is a perspective view illustrating the cylinder of the linear compressor in accordance with the present invention.

As depicted in FIG. 7, the cylinder 2 of the linear compressor includes a cylindrical cylinder main body 82 into which the piston 4 is inserted to form the compression space P therebetween, and a flange unit 82a protruded from the outer circumference of one end of the cylinder main body 82. The cylinder 2 is manufactured as an abrasion resistant powder sintered body with high hardness and an excellent abrasion characteristic.

Reference numerals which are not shown are identical to those of FIG. 1.

A mounting hole 82H is formed with a predetermined diameter in the axial direction at the center portion of the cylinder main body 82, and engaged with the outside diameter of the piston 4. The cylinder main body 82 is formed in a cylindrical shape with a sufficient thickness to resist a high pressure of compressing the refrigerants in the compression space P. The flange unit 82a is formed at one end of the cylinder main body 82 into which the piston 4 is inserted, and the compression space P is formed at the other end thereof.

In addition to the flange unit 82a, a straight line unit 82b for fixing the cylinder main body 82 to the frame 3, and a rotation prevention unit 82c to which the inner stator 12 of the linear motor 10 for driving the piston 4 is fixed are sintering molded on the outer circumference of the cylinder main body 82 as a single body.

In detail, the flange unit 82a is protruded from the outer circumference of the opposite side (the other end) to one end of the cylinder main body 82 having the compression space P. Preferably, the flange unit 82a is formed in a disk ring shape protruded along the circumferential direction, and disposed more inwardly than the other end of the cylinder main body 82 by a predetermined interval.

The straight line unit 82b contacts the frame 3, and prevents the cylinder main body 82 from being rotated in regard to the frame 3. Preferably, a pair of straight line units 82b are formed on both surfaces of the flange unit 82a, by partially cutting both sides of the flange unit 82a. It is also possible to change the shape and number of the straight line unit 82b.

Especially, the flange unit 82a is protruded from the outer circumference of the cylinder main body 82, and operated as a kind of electric resistance causing loss of the current generated by the linear motor 10. However, as the straight line units 82b are formed on the flange unit 82a, the cylinder main body 82 and the flange unit 82a can be symmetrically formed and the volume of the flange unit 82a can be reduced, to prevent eddy current loss.

The rotation prevention unit 82c is formed long in the axial direction on the outer circumference of the cylinder main body 82 in the region between one end of the cylinder main body 82 and the flange unit 82a. A plurality of rotation prevention units 82c can be formed in the partial region in the axial direction or at regular intervals in the circumferential direction.

The outside diameter of the cylinder main body 82 is smaller than the inside diameter of the inner stator 12. The inner stator 12 is inserted along the axial direction from one end of the cylinder main body 82. Accordingly, the inner circumference of the inner stator 12 is engaged with the rotation prevention unit 82c, so that the inner stator 12 can be fixed onto the cylinder main body 82 without rotation.

To evenly distribute the support force, at least two rotation prevention units 82c are preferably formed in the opposite directions of the outer circumference of the cylinder main body 82. More preferably, the height of the rotation prevention units 82c is over a tolerance between the outside diameter of the cylinder main body 82 and the inside diameter of the inner stator 12.

In the sintering molding of the cylinder 2, a slope can be formed around the flange unit 82a of the cylinder main body 82 to be inclined to the flange unit 82a. Therefore, when aluminum is die-cast into the frame 3, the frame 3 can be fixed to the cylinder 2 without special processing. As a result, the process of processing the sides of the cylinder 2 can be omitted.

The manufacturing process of the cylinder 2 will now be explained. A binder which is a kind of adhesive is added to powder with relatively high abrasion resistance such as metal powder or ceramic powder. The resulting mixture is put into a mold with the same size and shape as those of the cylinder 2 having the flange unit 82a, the straight line unit 82b and the rotation prevention unit 82c, fixed, and heated over a predetermined temperature. The boundaries of the powder are adhered to each other, to form the cylinder 2.

More preferably, after the piston 4 and the cylinder 2 are partially or wholly molded by using the sintering material and heated, steam processing is carried out thereon to form an oxide film serving as a protection film for preventing corrosion and giving a lubrication characteristic to the piston 4 and the cylinder 2.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A piston for linear compressor, wherein the linear compressor compresses refrigerants in a space between the piston and a cylinder and then discharges the compressed refrigerants, and wherein the piston is driven by a linear motor to be reciprocated inside the cylinder, characterized in that
the piston comprises a first piston member and a second piston member having a different thermal expansion coefficient from the first piston member, wherein the piston is manufacture by forcibly inserting a piston member with a relatively high thermal expansion coefficient into a heated piston member with a relatively low thermal expansion coefficient and wherein at least one of the first piston member and the second piston member is sintering molded.

2. The piston for linear compressor of claim 1, wherein the piston comprises a piston main body having a hollow cylindrical shape; a compression unit formed in a one end of the piston main body to compress the refrigerants in the space; and a connection unit formed in the other end of the piston main body to be extended in a radial direction, and wherein the first piston member includes the compression unit and an exterior part of the piston main body and the second piston member includes an interior part of the piston main body and the connection unit.

3. The piston for linear compressor of claim 1, wherein the piston comprises a piston main body having a hollow cylindrical shape; a compression unit formed in a one end of the piston main body to compress the refrigerants in the space; and a connection unit formed in the other end of the piston main body to be extended in a radial direction, and wherein the first piston member includes the compression unit and the piston main body and the second piston member includes the connection unit.

4. The piston for linear compressor of claim 1, wherein the piston comprises a piston main body having a hollow cylindrical shape; a compression unit formed in a one end of the piston main body to compress the refrigerants in the space; and a connection unit formed in the other end of the piston main body to be extended in a radial direction, and wherein the first piston member includes the compression unit and the second piston member includes the piston main body and the connection unit.

5. The piston for linear compressor of claim 2, wherein at least one communication hole for introducing the refrigerants into the space is formed in a one-body of the first piston member.

6. The piston for linear compressor of claim 2, wherein at least one fastening hole for connecting the piston to the linear motor is formed in a one body of the second piston member.

7. The piston for linear compressor of claim 5, wherein at least one fastening hole for connecting the piston to the linear motor is formed in a one body of the second piston member.

8. The piston for linear compressor of claim 3, wherein at least one communication hole for introducing the refrigerants into the space is formed in a one-body of the first piston member.

9. The piston for linear compressor of claim 3, wherein at least one fastening hole for connecting the piston to the linear motor is formed in a one body of the second piston member.

10. The piston for linear compressor of claim 8, wherein at least one fastening hole for connecting the piston to the linear motor is formed in a one body of the second piston member.

11. The piston for linear compressor of claim 4, wherein at least one communication hole for introducing the refrigerants into the space is formed in a one-body of the first piston member.

12. The piston for linear compressor of claim 4, wherein at least one fastening hole for connecting the piston to the linear motor is formed in a one body of the second piston member.

13. The piston for linear compressor of claim 11, wherein at least one fastening hole for connecting the piston to the linear motor is formed in a one body of the second piston member.
